(19) United States
(12) Patent Application Publication
(10) Pub. No.: US 2012/0126938 A1
(43) Pub. Date: May 24, 2012

(54) METHOD AND APPARATUS FOR GENERATING AN ACCESS CODE

(75) Inventors: Steven Friedlander, San Diego, CA (US); Manish Gupta, San Diego, CA (US); Jeffrey Tang, San Diego, CA (US); Jenny Su Chow, San Diego, CA (US)

(73) Assignee: SONY CORPORATION, Tokyo (JP)

(21) Appl. No.: 12/948,907

(22) Filed: Nov. 18, 2010

(51) Int. Cl. G05B 19/00

(52) U.S. Cl. 340/5.51

(57) ABSTRACT

Methods and apparatus are provided for generating an access code. In one embodiment, a method may include detecting user activation of a directional input of a device, wherein the user activation relates to a plurality of directional input commands, and determining an access code based on the user activation of the directional input, the access code including a plurality of code elements wherein each code element of the access code is associated with a direction of the directional input based on the user activation. The method may further include outputting code elements of the access code.

### FIELD

The present disclosure relates generally to input devices, and more particularly to methods and devices configured to generate an access code.

### BACKGROUND

Remote control devices typically employ a plurality of buttons for operation of a device. In particular, conventional devices employed for controlling operation of another device to access content, and for device control, can require a user to enter a password or code. Thus, many devices employ a numerical keypad to allow for a user to enter a code value. Similarly, many personal communication devices, and electronic devices in general, utilize one or more numerical buttons or buttons of an interface to select numerical values for entering an access code. Mobile communication devices may allow a user to lock a handset, and require the user to enter the correct numerical pass code in order to unlock the handset. However, there exists a desire from may users of devices to minimize the number of buttons a control device includes. For example, many users desire a control device that does not include a numerical key pad. Similarly, many users of electronic devices desire a solution for entering an access code that does not require a numerical keypad. For example, some media players do not include a numerical keypad. Other devices, such as typical mobile communication devices may include a slide keypad that can require a user to remove a hideaway numerical keypad to enter an access code. What is desired is a solution that allows for generating an access code that overcomes one or more above-identified drawbacks.

### BRIEF SUMMARY OF THE EMBODIMENTS

Disclosed and claimed herein are methods and apparatus for generating an access code. In one embodiment, a method includes detecting user activation of a directional input of a device, wherein the user activation relates to a plurality of directional input commands and determining an access code based on the user activation of the directional input, the access code including a plurality of code elements wherein each code element of the access code is associated with a direction of the directional input based on the user activation. The method further includes outputting, by the device, code elements of the access code.

Other aspects, features, and techniques will be apparent to one skilled in the relevant art in view of the following detailed description of the embodiments.

### BRIEF DESCRIPTION OF THE DRAWINGS

The features, objects, and advantages of the present embodiments will become more apparent from the detailed description set forth below when taken in conjunction with the drawings in which like reference characters identify correspondingly throughout and wherein:

FIG. 1 depicts a graphical representation of a device according to one embodiment;

FIG. 2 depicts a process for generating an access code according to one embodiment;

FIG. 3 depicts a simplified block diagram of a device according to one embodiment;

FIGS. 4A-4B depict graphical representations of access codes according to one or more embodiments; and

FIG. 5 depicts a graphical representation of output of an access code according to one or more embodiments.

### DETAILED DESCRIPTION OF THE EXEMPLARY EMBODIMENTS

### Overview and Terminology

One embodiment relates to methods for generating an access code. For example, a process for generating an access code is provided that can include detecting user activation of a directional input of a device. In one embodiment, an access code may include a plurality of code elements, wherein each code element of the access code is associated with a direction of the directional input based on the activation. The directional input may be employed to provide a plurality of directional input commands wherein the directional input commands may be employed as code elements to determine an access code. The method may further include outputting code elements of the access code for operation of the device. For example, an access code may be transmitted to a display device, wherein the access code is generated by a remote control. In another embodiment, output of the access code may unlock and/or provide access to one or more features and/or files of a device.

In another embodiment, a device is provided that may generate an access code based on user activation of a directional input. The device may relate to a control device and may be configured to transmit the access code in discrete elements based on user activation of a directional input. For example, code elements associated with a particular direction input may be transmitted as a single code element. In certain embodiments, the code elements of the access code may be transmitted as entered by the user.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

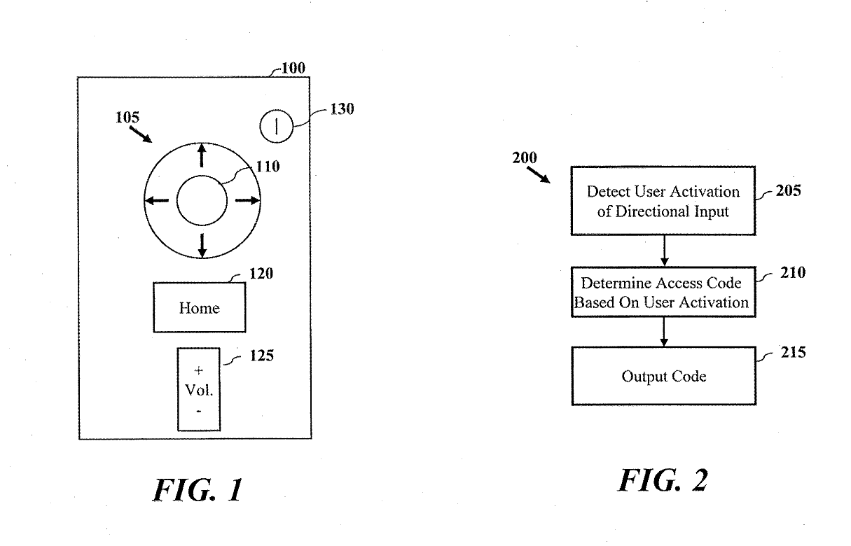

Referring now to the figures, FIG. 1 depicts a graphical representation of a device according to one or more embodiments. In one embodiment, device 100 may be configured to for generating an access code based on user activation of directional input 105. In particular, device 100 may be configured to provide an access code, and/or one or more code elements for operation of a device. In one embodiment, user activation of directional input 105 may be employed for determining an access code for device 100. Accordingly, device 100 may relate to one or more of a computer device, personal communication device, media player, and device in general. In another embodiment, user activation of device 100 may be employed for transmitting a signal by device 100 to one or more devices. In that fashion, device 100 may relate to one or more of a control device (e.g., remote control) and transmitter for a second device, such as a display device for example.

As depicted in FIG. 1, device 100 includes directional input 105 which may be configured to detect user activation of one or more directions. In one embodiment, directional input 105 relates to a directional keypad configured to detect activation for the one or more directions depicted (e.g., up, down, left, right). It should also be appreciated that the directional keypad may be configured to detect activation of additional inputs including rotation of the directional input and/or other directions (e.g., up and left, up and right, down and left, down and right). According to another embodiment, directional input 105 may relate to a plurality of buttons, such as a button for each of an up direction, down direction, left direction and right direction. In certain embodiments, directional input 105 may relate to a rotary input device to allow for detecting directional input and user scrolling (e.g., jog wheel functionality, rotary sensor, etc.).

In certain embodiments, directional input 105 may relate to one or more of hard and soft keys. Directional input 105 may further relate to a touch control, wherein the directional input may be displayed or relate to a sensor configured to detect user touch for detecting one or more directional inputs. As such, it may be appreciated that device 100 includes a display in certain embodiments.

Directional input 105 may further include button 110. Button 110 may be activated by a user to select a displayed item when device 100 relates to a remote control or a device with a display. Device 100 may further include home button 120 which may be selected by a user to generate a command for a home menu of a device. Device 100 may additionally include volume input 125 which may be employed to generate one or more volume adjustment commands for output and/or transmission. Device 100 may additionally include power button 130 which may be employed to turn a device on and off.

Referring now to FIG. 2, a process is depicted for generating an access code according to one or more embodiments. Process 200 may be employed for providing an access code to a device, such as an access code for one or more of a display device, media player, personal communication device, and device in general. Process 200 may be initiated by detecting user activation of a directional input (e.g., directional input 105) of a device (e.g., device 100) at block 205. In one embodiment, the user activation may relate to a plurality of directional input commands. Directional input commands may relate to activation of one of a directional keypad of the device and a plurality of directional buttons.

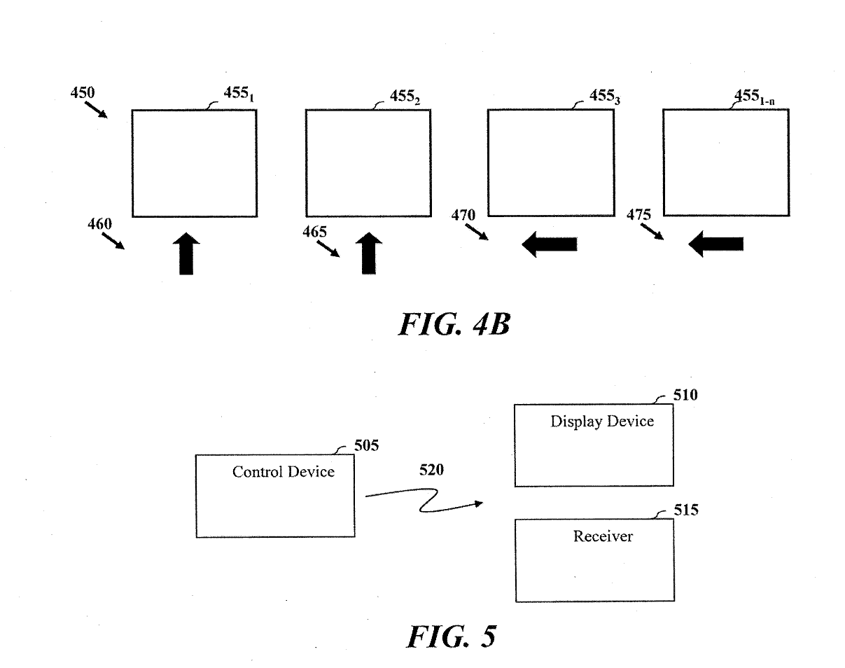

At block 210, an access code may be determined based on the user activation of the directional input. The access code may relate to a plurality of code elements wherein each code element of the access code is associated with a direction of the directional input based on the user activation. As will be discussed in more detail below with respect to FIGS. 4A-4B, the code elements may relate to user activation of the directional input to generate a series of direction inputs. Based on the user activation, an access code may be generated for at least one of a password, pin code and access code. In another embodiment, the access code may relate to a code for operation of a second device, such as a password, pin code, parental lock, etc.

At block 215, code elements of the access code may be output for operation of a device. In one embodiment, output of the code elements may relate to transmitting the code elements to a second device. In another embodiment, output of the code elements relates to processing each of the code elements singularly for control of the device. In yet another embodiment, process 200 may include detecting user activation of a command button (e.g., button 110) of the device, wherein output of the code elements is based on user activation of the command button.

Although, process 200 has been described above with reference to generating an access code, it should be appreciated that other types of data and/or codes may be generated based on process 200.

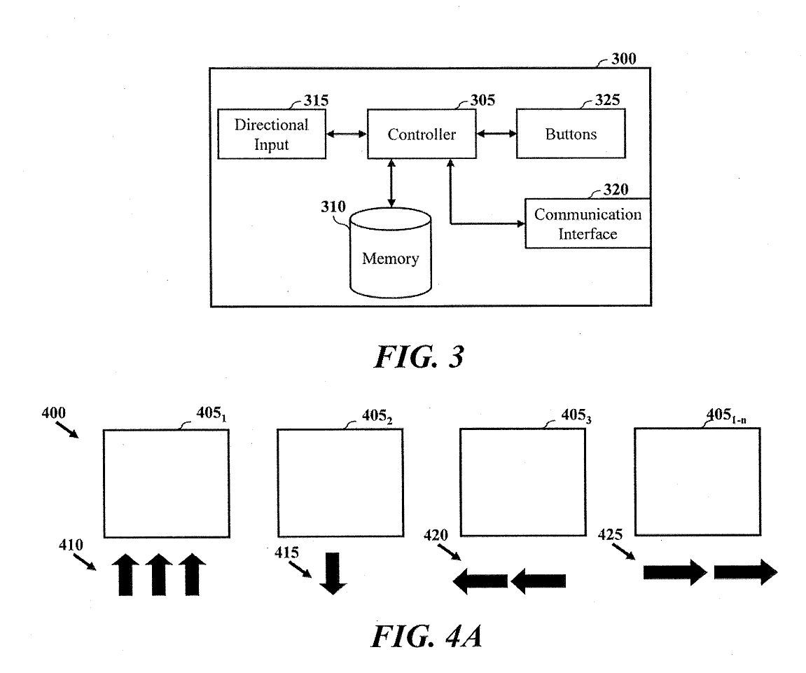

Referring now to FIG. 3, a simplified block diagram is depicted of a device according to one embodiment. In one embodiment, device 300 relates to the device of FIG. 1. Device 300 may be configured to detect user activation of a directional input to generate one or more code elements of an access code. As depicted in FIG. 3, device 300 includes controller 305, memory 310, directional input 315, communication interface 320 and one or more buttons depicted as 325. Controller 305 may be configured to control operation of device 300 based on one or more computer executable instructions stored in memory 310. Memory 310 may relate to one of RAM and ROM memories and may be configured to store one or more files, and computer executable instructions for operation of device 300.

Directional input 315 may include one or more buttons for user input, such as one of a directional keypad a plurality of directional buttons. Communication interface 320 may be configured to allow for transmitting a user command to one or more devices via wired or wireless communication (e.g., Bluetooth™, infrared, etc.). Buttons 325 of device 300 may relate to one or more user control buttons of a device, such as a home button (e.g., home button 120), volume adjustment button (e.g., volume adjustment 125) and a power button (e.g., power button 130). In one embodiment, buttons and/or user inputs of device 300 may relate to one or more buttons (e.g., keypad, keyboard, soft keys, etc.) that may be configured for a user to enter characters.

Referring now to FIGS. 4A-4B, graphical representations of access codes are depicted according to one or more embodiments. Referring first to FIG. 4A, access code 400 is depicted. According to one embodiment, an access code may include a plurality of code elements, each code element relating to a discrete element or value of the access code. In contrast to typical methods and devices which employ numerical digits selected by a dedicated button or selection of a digit via an interface, code elements as described herein may relate to and be entered by directional inputs. For example, verification of an access code may be based on comparison of code elements, such as a specific sequence of directional inputs. Code elements of access code 400 are depicted as 405₁₋ₙ. In one embodiment, an access code may be based on four code elements as depicted in FIG. 4A. It should be appreciated that an access code may be based on one or more additional, or fewer, code elements. Code elements 405₁₋ₙ may be set and/or entered by a user employing the device of FIG. 1 including a directional input. FIG. 4A, depicts exemplary values 410, 415, 420 and 425 for code elements based on user activation of a directional input. Code element 405₁, for example, relates to three directional elements in the “up” direction. Code elements 415, 420 and 425 may relate to a single down directional activation, two left directional activations and two right directional activations respectively. According to one embodiment, a change in selection of a direction arrow may be employed to distinguish each code element.

FIG. 4B, depicts an access code according to another embodiment. According to one embodiment, an access code may not require activation of each direction of a directional input. As depicted in FIG. 4B, access code 450 includes code elements 455₁₋ₙ, wherein the direction inputs 455, 460, 465 and 470 relate to a single up directional activation, followed by a single up direction, and two single left directions, respectively. As such, code elements of FIGS. 4A-4B allow for a user to input an access code without requiring a device to include a numerical keypad.

Referring now to FIG. 5, a graphical representation is depicted of output of an access code according to one or more embodiments. According to one embodiment, an access code may be output by a device, such as a remote control for control and/or operation of another or second device. Control device 500 (e.g., device 100) may relate to a control for one or more devices (e.g., a second device) depicted as display device 510 and receiver 515. In one embodiment, user activation of a directional input of control device may be employed for detecting and access code for transmission to display device 505 and/or receiver 515, depicted as 520. Transmission by control device 505 may relate to wireless transmissions (e.g., IR, RF, Bluetooth™). In one embodiment, control device 505 may be configured to initiate a transmission each time a user activation of a directional input is detected. According to another embodiment, control device 505 may be configured to transmit a signal identifying a directional input and number of times associated with the direction for a plurality of code elements.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for generating an access code, the method comprising the acts of:
detecting user activation of a directional input of a device, wherein the user activation relates to a plurality of directional input commands;
determining an access code based on the user activation of the directional input, the access code including a plurality of code elements wherein each code element of the access code is associated with a direction of the directional input based on the user activation; and
outputting code elements of the access code.

2. The method of claim 1, wherein the directional input commands relate to activation of one of a directional keypad of the device and a plurality of directional buttons of the device.

3. The method of claim 1, wherein the access code relates to at least one of a password, pin code and access code.

4. The method of claim 1, wherein the access code relates to a code for operation of a second device.

5. The method of claim 1, wherein output of the code elements relates to transmitting the code elements to a second device.

6. The method of claim 1, wherein output of the code elements relates to determining each of the code elements singularly for control of the device.

7. The method of claim 1, further comprising detecting user activation of a command button of the device, wherein output of the code elements is based on user activation of the command button.

8. A computer program product stored on computer readable medium including computer executable code for generating an access code, the computer program product comprising:
computer readable code to detect user activation of a directional input of a device, wherein the user activation relates to a plurality of directional input commands;
computer readable code to determine an access code based on the user activation of the directional input, the access code including a plurality of code elements wherein each code element of the access code is associated with a direction of the directional input based on the user activation; and
computer readable code to output code elements of the access code.

9. The computer program product of claim 8, wherein the directional input commands relate to activation of one of a directional keypad of the device and a plurality of directional buttons of a device.

10. The computer program product of claim 8, wherein the access code relates to at least one of a password, pin code and access code.

11. The computer program product of claim 8, wherein the access code relates to a code for operation of a second device.

12. The computer program product of claim 8, wherein output of the code elements relates to transmitting the code elements to a second device.

13. The computer program product of claim 8, wherein output of the code elements relates to determining each of the code elements singularly for control of the device.

14. The computer program product of claim 8, further comprising computer readable code to detect user activation of a command button of the device, wherein output of the code elements is based on user activation of the command button.

15. A device comprising:
a directional input; and
a controller coupled to the directional input, the controller configured to
detect user activation of the directional input, wherein the user activation relates to a plurality of directional input commands;
determine an access code based on the user activation of the directional input, the access code including a plurality of code elements wherein each code element of the access code is associated with a direction of the directional input based on the user activation; and
output code elements of the access code.

16. The device of claim 15, wherein the device relates to a wireless transmitter.

17. The device of claim 15, wherein the directional input commands relate to activation of one of a directional keypad of the device and a plurality of directional buttons of the device.

18. The device of claim 15, wherein the access code relates to at least one of a password, pin code and access code.

19. The device of claim 15, wherein the access code relates to a code for operation of a second device.

20. The device of claim 15, wherein output of the code elements relates to transmitting the code elements to a second device.

21. The device of claim 15, wherein output of the code elements relates to determining each of the code elements singularly for control of the device.

22. The device of claim 15, wherein the controller is further configured to detect user activation of a command button of the device, wherein output of the code elements is based on user activation of the command button.
